(19) United States
(12) Patent Application Publication
(10) Pub. No.: US 2024/0164880 A1
(43) Pub. Date: May 23, 2024

(54) FLOSSER DEVICE

(71) Applicant: SMILE MAKERS, LLC, San Diego, CA (US)

(72) Inventor: Kami Hoss, San Diego, CA (US)

(21) Appl. No.: 18/550,578

(22) PCT Filed: Mar. 11, 2022
(86) PCT No.: PCT/US2022/019991

§ 371 Date: Sep. 14, 2023

Related U.S. Application Data
(60) Provisional application No. 63/161,279, filed on Mar. 15, 2021.

(51) Int. Cl. A61C 15/04

(52) U.S. Cl. CPC A61C 15/048

(57) ABSTRACT

A flosser device comprises a handle configured to be held by a user, the handle extending along a longitudinal axis of the flosser device, the handle comprising a first slot extending into the handle at a first angle and a second slot extending into the handle at a second angle that is different from the first angle. The flosser device can further comprise a flosser arm assembly configured to support dental floss during use by the user, the flosser arm assembly configured to removably connect to the handle, the flosser arm assembly comprising a connection flange configured to removably engage with the first and second slots to position the flosser arm assembly at the respective first and second angles.

### INCORPORATION BY REFERENCE TO ANY PRIORITY APPLICATIONS

Any and all applications for which a foreign or domestic priority claim is identified in the Application Data Sheet or Request as filed with the present application are hereby incorporated by reference in their entirety under 37 CFR 1.57, and Rules 4.18 and 20.6, including U.S. Provisional Application No. 63/161,279, filed Mar. 15, 2021.

### BACKGROUND

### Field

The field relates to a flosser device.

### Description of the Related Art

Flossing is a critical component of a person's overall health. In particular, flossing helps remove plaque and other dental deposits that may be present between teeth and/or along the gum line. Ineffective flossing can cause tooth decay, which can be damaging to the person's oral health and may also cause other health problems, such as cardiovascular disease. There remains a continuing need for improved flossing devices that can improve the overall health of the user.

### SUMMARY

In one embodiment, a flosser device includes a handle configured to be held by a user, the handle extending along a longitudinal axis of the flosser device; and a flosser arm assembly configured to support dental floss during use by the user, the flosser arm assembly configured to removably connect to the handle at a first connection location to position the flosser arm assembly at a first angle relative to the longitudinal axis, the flosser arm assembly further configured to removably connect to the handle at a second connection location to position the flosser arm assembly at a second angle relative to the longitudinal axis, the second angle different from the first angle, the second connection location spaced from the first connection location along the longitudinal axis.

In some embodiments, the handle comprises a first slot at the first connection location and a second slot at the second connection location, the first slot extending into the handle at the first angle and the second slot extending into the handle at the second angle. In some embodiments, the flosser arm assembly comprises a first arm extending from a connection flange and a second arm extending from the connection flange, the first arm spaced apart from the second arm, the connection flange sized and shaped to be removably insertable into the first and second slots. In some embodiments, the at least one connection flange is removably engageable with the first and second slots by way of a snap-fit connection. In some embodiments, the flosser device can include the dental floss, the dental floss extending between the first and second arms. In some embodiments, the flosser device can include a container coupled to or formed with the handle, the dental floss extending from within the container to the first and second arms. In some embodiments, each of the first and second arms comprises a plurality of joints, the plurality of joints configured to adjust an angle between distal ends of the first and second arms and the longitudinal axis of the handle. In some embodiments, the first and second slots are formed in a front side of the handle, the front side of the handle configured to face the user during operation of the flosser device. In some embodiments, the first angle is in a range of 30° to 50°, and wherein the second angle is in a range of 80° to 100°. In some embodiments, the first angle is in a range of 35° to 45°, and wherein the second angle is in a range of 89° to 91°. In some embodiments, the first and second slots are formed in a back side of the handle, the back side of the handle configured to face away from the user during operation of the flosser device. In some embodiments, the flosser device can include a fluid reservoir coupled to or formed with the handle and a liquid supply line extending from the fluid reservoir to the arm assembly to supply a liquid to the dental floss and/or a mouth of the user.

In another embodiment, a flosser device can include a handle configured to be held by a user, the handle extending along a longitudinal axis of the flosser device; a flosser arm assembly configured to support dental floss during use by the user; and a connection mechanism configured to removably connect the flosser arm assembly to the handle at a plurality of angular orientations relative to the longitudinal axis of the handle, wherein the connection mechanism positions the flosser arm assembly at a first angle relative to the longitudinal axis in a first operational configuration of the flosser device, and wherein the connection mechanism positions the flosser arm assembly at a second angle relative to the longitudinal axis in a second operational configuration, the second angle different from the first angle, the connection mechanism configured to move from the first operational configuration to the second operational configuration by a physical separation between the flosser arm assembly and the handle followed by a subsequent physical connection between the flosser arm assembly and the handle at the second angle.

In some embodiments, the connection mechanism comprises at least one connecting member and at least one slot, wherein one of the at least one connecting member and the at least one slot is coupled to or formed with the handle, and wherein the other of the at least one connecting member and the at least one slot is coupled to or formed with the flosser arm assembly. In some embodiments, the flosser arm assembly comprises the at least one connecting member, and wherein the at least one slot comprises a plurality of slots formed in the handle. In some embodiments, the plurality of slots are spaced apart along the longitudinal axis of the handle. In some embodiments, the plurality of slots are provided within a common aperture in the handle. In some embodiments, the plurality of slots comprises a first slot extending into the handle at the first angle and a second slot extending into the handle at the second angle. In some embodiments, the at least one connecting member is removably engageable with the first and second slots by way of a snap-fit connection. In some embodiments, the flosser arm assembly comprises a first arm extending from the at least one connecting member and a second arm extending from the at least one connecting member, the first arm spaced apart from the second arm. In some embodiments, the flosser device can include the dental floss, the dental floss extending between the first and second arms. In some embodiments, the flosser device can include a container coupled to or formed with the handle, the dental floss extending from within the container to the first and second arms. In some embodiments, each of the first and second arms comprises a plurality of joints, the plurality of joints configured to adjust an angle between distal ends of the first and second arms and the longitudinal axis of the handle. In some embodiments, the plurality of slots are formed in a front side of the handle, the front side of the handle configured to face the user during operation of the flosser device. In some embodiments, the first angle is in a range of 30° to 50°, and wherein the second angle is in a range of 80° to 100°. In some embodiments, the first angle is in a range of 35° to 45°, and wherein the second angle is in a range of 89° to 91°. In some embodiments, the plurality of slots are formed in a back side of the handle, the back side of the handle configured to face away from the user during operation of the flosser device. In some embodiments, the flosser device can include a fluid reservoir coupled to or formed with the handle and a liquid supply line extending from the fluid reservoir to the arm assembly to supply a liquid to the dental floss and/or a mouth of the user. In some embodiments, the at least one connecting member comprises a projection coupled to or formed with the handle, and wherein the at least one slot comprises a plurality of slots formed at a plurality of angular orientations in the flosser arm assembly.

In another embodiment, a flossing method can include removably connecting a flosser arm assembly to a handle at a first angle relative to a longitudinal axis of the handle; physically separating the flosser arm assembly from the handle; and removably connecting the flosser arm assembly to the handle at a second angle relative to the longitudinal axis of the handle, the second angle different from the first angle.

In some embodiments, removably connecting the flosser arm assembly to the handle at the first angle comprises inserting a connection flange of the flosser arm assembly into a first slot formed in the handle at the first angle, and wherein removably connecting the flosser arm assembly to the handle at the second angle comprises inserting the connection flange into a second slot formed in the handle at the second angle. In some embodiments, removably connecting the flosser arm assembly to the handle at the first angle comprises inserting a projection of the handle into a first slot formed in the flosser arm assembly at the first angle, and wherein removably connecting the flosser arm assembly to the handle at the second angle comprises inserting the projection into a second slot formed in the flosser arm assembly at the second angle.

In another embodiment, a flossing device can include a handle configured to be held by a user, the handle extending along a longitudinal axis of the flosser device; and a first flosser arm having a first proximal portion connected to the handle and a first distal portion opposite the first proximal portion, the first distal portion configured to support dental floss during use by the user, the first flosser arm including a first plurality of rotatable joints configured to position the first distal portion at a first plurality of angular orientations relative to a mouth of the user.

In some embodiments, the flossing device can include a second flosser arm spaced apart from the first flosser arm, the second flosser arm having a second proximal portion connected to the handle and a second distal portion opposite the second proximal portion, the second distal portion configured to support the dental floss during use by the user, the second flosser arm including a second plurality of rotatable joints configured to position the second distal portion at a second plurality of angular orientations relative to the mouth of the user. In some embodiments, each of the first and second flosser arms comprises a first segment connected to the handle by a first rotatable joint at the proximal portion of the first flosser arm and a second segment connected to the first segment by a second rotatable joint. In some embodiments, the first and second rotatable joints are configured to rotate about rotational axes that are transverse to the longitudinal axis of the handle. In some embodiments, the first and second flosser arms are spaced apart along an arm axis parallel to the rotational axes. In some embodiments, each of the first and second flosser arms comprises a third segment connected to the second segment by a third rotatable joint, the third segment comprising the respective first and second distal portions. In some embodiments, the flossing device can include a fluid reservoir coupled to or formed with the handle and a liquid supply line extending from the fluid reservoir to the first flosser arm to supply a liquid to the dental floss and/or a mouth of the user. In some embodiments, the flossing device can include the dental floss and a container coupled to or formed with the handle, the dental floss extending from within the container to the first flosser arm.

In another embodiment, a flosser device can include a handle configured to be held by a user, the handle extending along a longitudinal axis of the flosser device, the handle comprising a first slot extending into the handle at a first angle and a second slot extending into the handle at a second angle that is different from the first angle; and a flosser arm assembly configured to support dental floss during use by the user, the flosser arm assembly configured to removably connect to the handle, the flosser arm assembly comprising a connection flange configured to removably engage with the first and second slots to position the flosser arm assembly at the respective first and second angles.

In some embodiments, the flosser arm assembly comprises a first arm extending from the connection flange and a second arm extending from the connection flange, the first arm spaced apart from the second arm. In some embodiments, the at least one connection flange is removably engageable with the first and second slots by way of a snap-fit connection. In some embodiments, the flossing device can include the dental floss, the dental floss extending between the first and second arms. In some embodiments, the first and second slots are spaced apart along the longitudinal axis of the handle. In some embodiments, the first and second slots are provided within a common aperture in the handle.

### BRIEF DESCRIPTION OF THE DRAWINGS

FIG. 1A is a schematic illustration of a flosser device including a handle and a detachable flosser arm assembly configured to removably attach to a front side of the handle at a plurality of angular orientations, according to various embodiments.

FIG. 1B is a schematic side view of a handle having a back side configured to removably engage with a detachable flosser arm, according to another embodiment.

FIG. 1C is a magnified side view of the handle shown in FIG. 1A, with the flosser arm assembly connected to the front side of the handle at a first angular orientation.

FIG. 1D is a magnified side view of the handle shown in FIG. 1A, with the flosser arm assembly connected to the front side of the handle at a second angular orientation.

FIG. 1E is a magnified side view of the handle shown in FIG. 1B, with the flosser arm assembly connected to the back side of the handle at a first angular orientation.

FIG. 1F is a magnified side view of the handle shown in FIG. 1B, with the flosser arm assembly connected to the back side of the handle at a second angular orientation.

FIG. 2A is a schematic perspective view of a flosser arm assembly, according to another embodiment.

FIG. 2B is a schematic side view of a handle configured to removably connect to the flosser arm assembly of FIG. 2A at a plurality of angular orientations.

FIG. 3A is a schematic front view of a flosser device, according to various embodiments.

FIG. 3B is a schematic side view of the flosser device of FIG. 3A.

FIG. 3C is a schematic side view of an articulating flosser arm in a first angular orientation, according to various embodiments.

FIG. 3D is a schematic side view of the articulating flosser arm of FIG. 3C in a second angular orientation.

FIG. 4A is a schematic top view of a flosser arm assembly, according to various embodiments.

FIG. 4B is a schematic front view of a flosser handle configured to removable connect to the flosser arm assembly of FIG. 4A at a plurality of angular orientations.

FIG. 4C is a schematic left side sectional view of the flosser handle of FIG. 4B, taken along section 4C-4C.

Throughout the drawings, unless otherwise noted, reference numbers may be re-used to indicate a general correspondence between referenced elements. The drawings are provided to illustrate example embodiments described herein and are not intended to limit the scope of the disclosure. The drawings are accordingly schematic and not necessarily drawn to scale.

### DETAILED DESCRIPTION

Various embodiments disclosed herein relate to an adjustable flosser device 1 configured to position a flosser arm assembly 3 at a plurality of angles relative to a handle 2 of the device 1. The flosser arm assembly 3 can be configured to support dental floss 6 during use by the user. In conventional flossing devices, it can be challenging for the user to maneuver the dental floss into the mouth and between adjacent teeth, particularly for posterior teeth, such as molars since the cheeks are in the way, and the inter-occlusal space gets reduced towards the back of the mouth. If the user has difficulty in flossing their teeth, the flossing may be ineffective and may promote decay. Accordingly, the embodiments disclosed herein can beneficially enable the user to adjust the angle between the flosser arm assembly 3 and the handle 2 so as to improve the usability (e.g., maneuverability) of the flosser device 1.

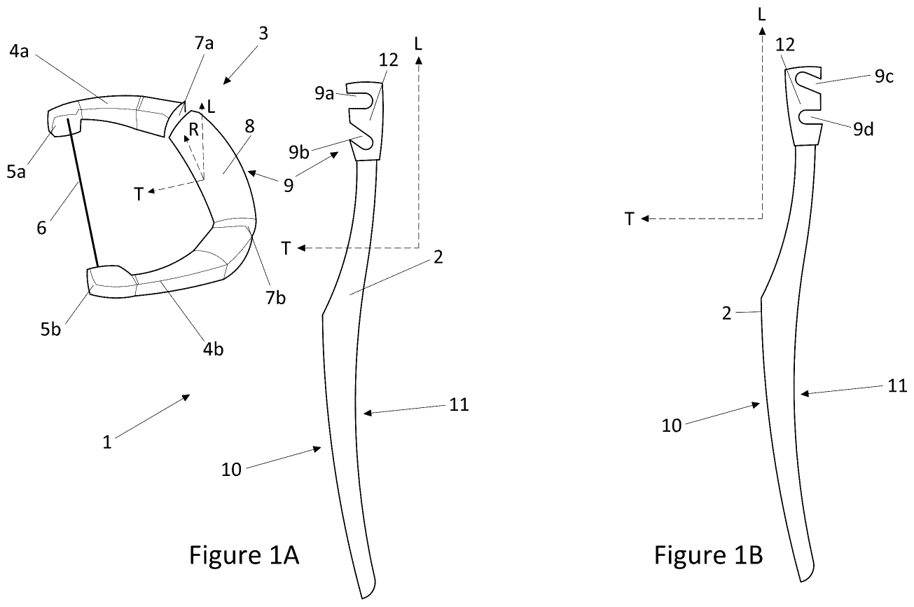

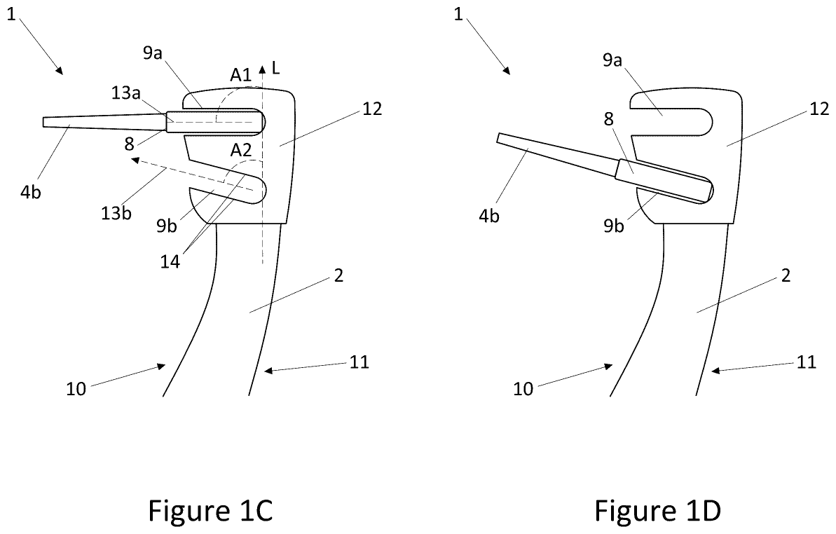

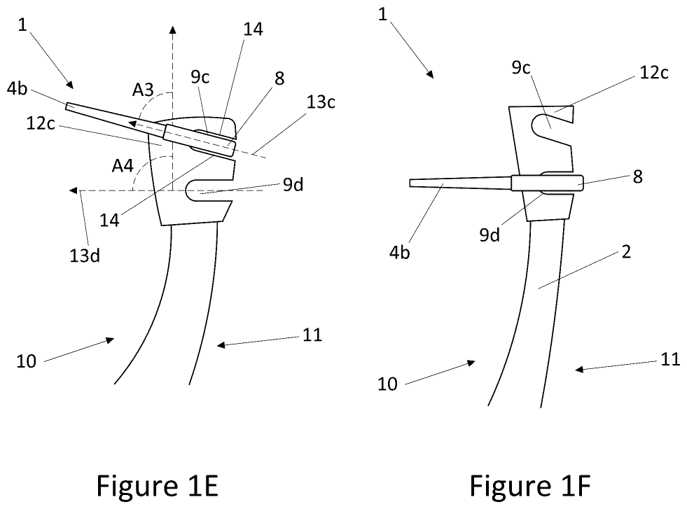

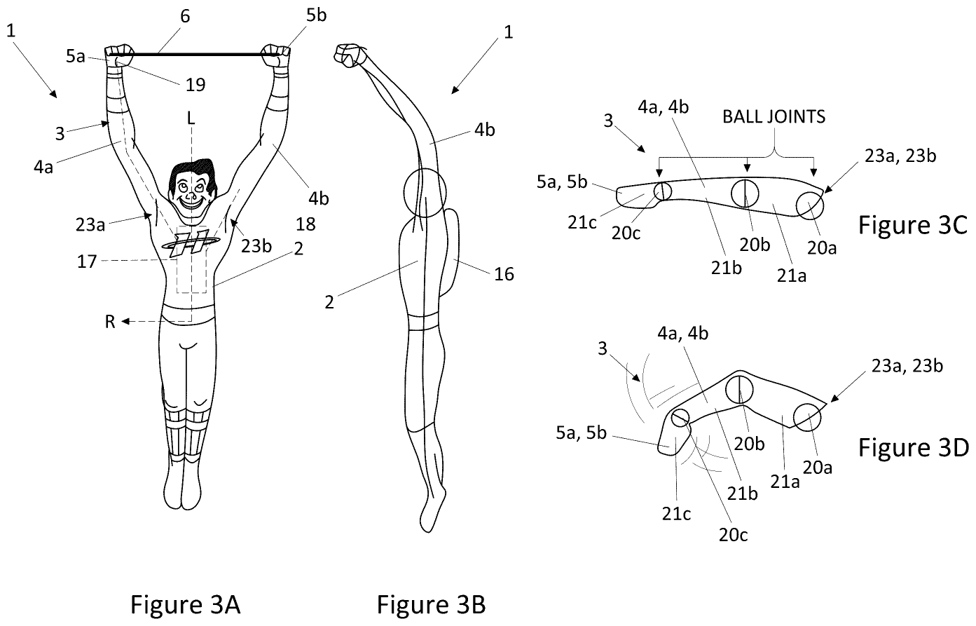

FIGS. 1A-1F illustrate various embodiments of a flosser device 1 having a flosser arm assembly 3 that is removably connectable to the handle 2 at a plurality of angular orientations. The handle 2 can comprise an elongate member extending generally along a longitudinal axis L of the flosser device 1. The handle 2 can be configured to be held by a user during use of the device 1. In some embodiments, the handle 2 can comprise ergonomic features to assist the user in gripping the device 1. In some embodiments, as explained below in connection with FIGS. 3A-3D, the handle 2 can comprise a character, such as a cartoon character, a superhero, an animal, or any other suitable type of character or body of an adult or child. The handle 2 can comprise a front side 10 configured to face a user during operation of the flosser device 1 and a back side 11 opposite the front side 10. The back side 11 can be configured to face away from the user during operation of the flosser device 1. The front and back sides 10, 11 can be disposed generally parallel to a transverse axis T that is perpendicular to the longitudinal axis L.

The flosser arm assembly 3 can comprise a connection flange 8, a first arm 4a extending from the connection flange 8, and a second arm 4b extending from the connection flange 8. As shown, the first arm 4a can be spaced apart from the second arm 4b along an arm axis R transverse to the longitudinal L and transverse Taxes. Note that, in the inset image of the flosser arm assembly 3 of FIG. 1A, the arms 4a, 4b are illustrated as extending generally parallel to the transverse axis T, but it should be appreciated that in other angular orientations, the arms 4a, 4b may be disposed at a non-zero angle relative to the transverse axis T. The first and second arms 4a, 4b can comprise corresponding first and second distal portions 5a, 5b. Dental floss 6 can be connected to and suspended between the first and second distal portions 5a, 5b. In some embodiments, the floss 6 can comprise a strand that is affixed to the first and second distal portions 5a, 5b. In other embodiments, as explained below in connection with FIGS. 3A and 3B, the dental floss 6 can be stored in a container coupled to or formed with the handle 2. In such embodiments, the floss 6 can be spooled onto a roller in the container and fed through or along the arms 4a, 4b. Further, in some embodiments, as explained below in connection with FIGS. 3A and 3B, a treatment liquid (such as mouthwash, antibacterial agent, or the like) can be dispensed on the floss 6 before, during, and/or after flossing.

In FIG. 1A, the first and second arms 4a, 4b can connect to the connection flange 8 by way of respective first and second joints 7a, 7b. In some embodiments, the first and second joints 7a, 7b may comprise fixed-angle joints that serve to connect the first and second arms 4a, 4b to the connection flange 8 at the corresponding fixed angles shown in FIG. 1A. In such embodiments, the arms 4a, 4b may not rotate or pivot relative to the joints 7a, 7b. In other embodiments, however, and as explained below in connection with FIGS. 3C and 3D, the joints 7a, 7b may comprise rotatable joints (e.g., ball joints) such that the first and second arms 4a, 4b may rotate or pivot relative to the connection flange 8 may way of the joints 7a, 7b. Further, as explained below, multiple joints may be disposed along cach arm 4a, 4b between the respective arm 4a, 4b and the connection flange 8.

As shown in FIG. 1A, the flosser device 1 can include a connection mechanism 9 configured to removably connect the flosser arm assembly 3 to the handle 2 at a plurality of angular orientations relative to the longitudinal axis L of the handle 2. As explained herein, the connection mechanism 9 can position the flosser arm assembly 3 at a first angle A1 (sec, e.g., FIG. 1C) relative to the longitudinal axis L in a first operational configuration of the flosser device 1. The connection mechanism 9 can position the flosser arm assembly 3 at a second angle A2 (sec, e.g., FIG. 1D) relative to the longitudinal axis L in a second operational configuration, the second angle A2 different from the first angle A2. In various disclosed embodiments, the connection mechanism 9 can be configured to move from the first operational configuration to the second operational configuration by a physical separation between the flosser arm assembly 3 and the handle 2, followed by a subsequent physical connection between the flosser arm assembly 3 and the handle 2 at the second angle A2, or vice versa (e.g., from the second operational configuration to the first operational configuration).

The connection mechanism 9 can comprise the connection flange 8 of the flosser arm assembly 3 and a plurality of slots 9a, 9b formed in a head portion 12 of the handle 2. In the embodiment of FIGS. 1A and 1C-1D, the connection flange 8 can serve as a connecting member to removably connect to the slots 9a, 9b. The plurality of slots 9a, 9b can comprise a first slot 9a and a second slot 9b spaced apart from the first slot 9a along the longitudinal axis L of the handle 2. In the embodiment shown in FIGS. 1A and 1C-1D, the slots 9a, 9b can be formed in the front side 10 of the handle 2. The first slot 9a can extend into the front side 10 of the handle 2 at the first angle A1 relative to the longitudinal axis L. The first angle A1 can be measured between the longitudinal axis L along which the handle 2 generally extends and a first slot axis 13a. The first slot axis 13a extends from the longitudinal axis L generally parallel to opposing walls 14 of the slot 9a and generally facing the user. The second slot 9b can extend into the front side 10 of the handle 2 at the second angle A2 relative to the longitudinal axis L. The second angle A2 can be measured between the longitudinal axis L and a second slot axis 13b generally facing the user. In the embodiment of FIGS. 1A and 1C-1D, the first angle A1 can be in a range of 80° to 100°, in a range of 85° to 95°, in a range of 89° to 91°, or in a range of 89.5° to 90.5° e.g., about 90° in some embodiments. The second angle A2 can be in a range of 25° to 45°, in a range of 30° to 50°, in a range of 35° to 50°, in a range of 35° to 45°, or in a range of 35° to 40°. For example, in one embodiment, the second angle A2 can be approximately 37° so as to match the average interocclusal angle between opposing teeth. Beneficially, positioning the arms at the second angle A2 can enable the user to more easily access posterior teeth. In the illustrated embodiments, the angles A1, A2 can be measured relative to the longitudinal axis L extending distally or away from a lower end of the handle 2 that is disposed opposite the flosser arm assembly 3.

Beneficially, as shown in FIGS. 1C and 1D, the connection flange 8 of the flosser arm 8 can be removably engageable with the first and second slots 9a, 9b by way of a snap-fit connection. For example, in some embodiments, the connection flange 8 can be sized to have an interference fit with the slots 9a, 9b, such that the flange 8 snugly fits within the slots 9a, 9b during use of the flosser device 1. In some embodiments, a detent or latch mechanism (not shown) may additionally or alternatively be provided to removably connect the connection flange 8 to the slots 9a, 9b. It should be appreciated that, although two slots 9a, 9b are shown in FIGS. 1A and 1C-1D, any suitable number of slots may be provided. For example, in some embodiments, three, four, five, or more slots can be provided so as to provide additional angular orientations for the flosser arm assembly 3.

In use, the user can insert the flange 8 into one of the slots 9a, 9b to removably connect the flosser arm assembly 3 to the handle 2. As explained above, the flange 8 can snap into the slots 9a, 9b in some embodiments. For example, the user may initially place the flange 8 into the first slot 9a in a first operational configuration at the first angle A1. Positioning the flange 8 into the first slot 9a can orient the flosser arms 4a, 4b at a first angular orientation relative to the mouth. If the user wishes to change the angular orientation of the flosser arms 4a, 4b, the user can disengage the arm assembly 3 from the handle 2 by physically removing (e.g., pulling) the flange 8 out of the first slot 9a, and physically connecting (e.g., inserting or snapping) the flange 8 into the second slot 9b. Positioning the flange 8 into the second slot 9b can orient the flosser arms 4a, 4b at a second angular orientation relative to the mouth. As shown, for example, the second angular orientation may be at a smaller angle relative to the longitudinal axis L as shown schematically in FIG. 1C. The user can similarly physically separate the flange 8 from the handle 2 by removing the flange 8 from the second slot 9b, and can physically connect (e.g., insert or snap) the flange 8 into the first slot 9a. In some embodiments, the flosser arm assembly 3 may be tethered to the handle 2 (e.g., with a string) so as to keep the two components in proximity. The tether can connect the handle 2 to the flosser arm assembly 3 when the flosser arm assembly is physically separated from or disengaged from the handle 2 (e.g., from the slots 9a, 9b).

In other embodiments, as shown in FIGS. 1B and 1E-1F, slots 9c, 9d can alternatively or additionally be provided in the back side 11 of the handle 2 that faces away from the user in use. As with the embodiment of FIGS. 1A and 1C-1D, the slot 9c can be disposed at a third angle A3 between the longitudinal axis L and a third slot axis 13c that extends generally parallel to opposing walls 14 of the slot 9c and generally facing the user. Similarly, the slot 9c can be disposed at a fourth angle A4 between the longitudinal axis L and a fourth slot axis 13c generally facing the user. In various embodiments, the third angle A3 can be the same as the second angle A2, e.g., in a range of 25° to 45°, in a range of 30° to 50°, in a range of 35° to 50°, in a range of 35° to 45°, or in a range of 35° to 40°, for example, approximately 37° in various embodiments. The fourth angle A4 can be in a range of 80° to 100°, in a range of 85° to 95°, in a range of 89° to 91°, or in a range of 89.5° to 90.5° e.g., about 90° in some embodiments. In the illustrated embodiments, the angles A3, A4 can be measured relative to the longitudinal axis L extending distally or away from a lower end of the handle 2 that is disposed opposite the flosser arm assembly 3. As explained above, the user can select a desired angular orientation of the flosser arm assembly 3 by inserting (e.g., snapping) the flange 8 into the desired slot 9c, or 9d. The user can change angular orientations by physically separating the flange 8 from the handle 2 (e.g., from one of the slots 9c or 9d) and inserting the flange 8 into the other slot 9c or 9d.

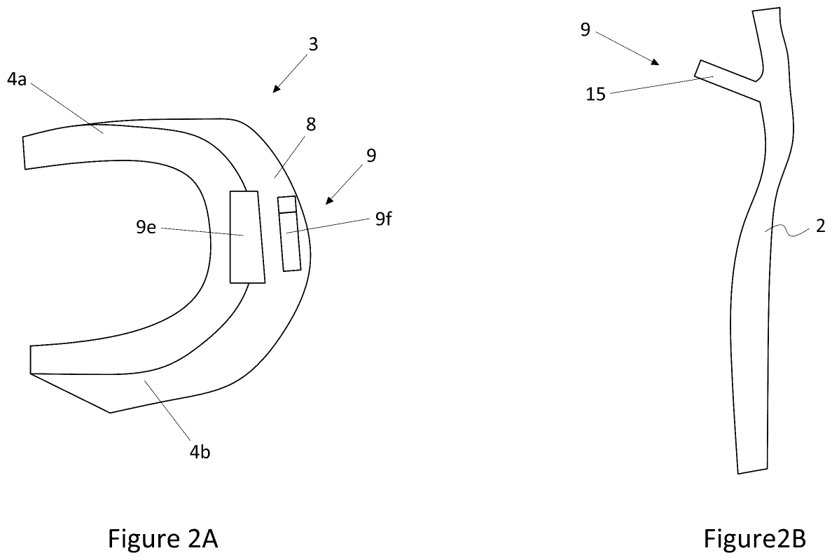

Turning to FIGS. 2A and 2B, unless otherwise noted, reference numerals in FIGS. 2A-2B may be the same as or generally similar to like numbered components of FIGS. 1A-1F. As with FIGS. 1A-1F, the flosser device 1 can include a connection mechanism 9 that removably connects the flosser arm assembly 3 to the handle 2 at a plurality of angular orientations. Unlike the embodiments of FIGS. 1A-1F, in the connection mechanism 9 of FIGS. 2A-2B, slots 9e, 9f may be formed in the flosser arm assembly 3 (e.g., in the connection flange 8), and one or more projections 15 can be coupled to or formed with the handle 2. As shown in FIG. 2A, the slots 9e. 9f can be provided in the arm assembly 3 at different angular orientations. The projection 15 can serve as a connecting member to removably connect to the slots 9e. 9f. The projection 15 can extend from the handle 2 at a non-zero angle. The user can insert the projection 15 into the slot 9e to orient the flosser arm assembly 3 relative to the mouth at a first angular orientation. As above, the projection 15 can be sized or configured to provide an interference or snap-fit connection with the slots 9c, 9f. To change angular orientations, the user can physically remove (e.g., pull) the projection 15 out of the slot 9e, and can insert the projection 15 into the other slot 9f. Similar, the user can remove the projection 15 from slot 9f and insert the projection 15 into slot 9e. As above, any suitable number of slots (e.g., three, four, five, or more) may be provided in the arm assembly 3. As with the embodiments of FIGS. 1A-1F, the embodiment of FIGS. 2A-2B can enable the user to more effectively floss their teeth by allowing for flossing at different angular orientations, improving health outcomes for the user.

FIGS. 3A-3D illustrate a flosser device 1, according to another embodiment. Unless otherwise noted, reference numerals in FIGS. 3A-3D illustrate components that may be the same as or generally similar to like-numbered components of FIGS. 1A-2B. For example, as with FIGS. 1A-2B, the flosser device 1 can comprise a handle 2 configured to be held by a user, the handle 2 extending along a longitudinal axis L of the flosser device 1. In the illustrated embodiment, the handle 2 can take the shape of a character, such as a cartoon character, a superhero, an animal, or any other suitable character. Incorporating a character into the handle 2 can be pleasing to the user (e.g., for pediatric flossing devices). A flosser arm assembly 3 can be connected to the handle 2. The flosser arm assembly 3 can include a first flosser arm 4a and a second flosser arm 4b spaced apart from one another along an arm axis R that is generally transverse to the longitudinal axis L.

The first and second flosser arms 4a, 4b can each include respective first and second proximal portions 23a, 23b connected to the handle 2. Respective first and second distal portions 5a, 5b can be disposed opposite the proximal portions 23a, 23b and can be configured to support the dental floss 6 during use by the user. The first and second flosser arms 4a, 4b can each include a plurality of rotatable joints 20a-20c configured to position the first and second distal portions 5a, 5b at a respective plurality of angular orientations relative to the mouth of the user. Each of the first and second flosser arms 4a, 4b can comprise a first segment 21a connected to the handle 2 by a first rotatable 20a joint at the proximal portion 23a, 23b of the first flosser arm 4a, 4b, a second segment 21b connected to the first segment 21a by a second rotatable joint 20b, and a third segment 21c connected to the second segment 21b by a third rotatable joint 20c. In the illustrated embodiment, the third segments 21c of the first and second arms 4a, 4b can comprise the distal portions 5a, 5b that support the floss 6.

Although three rotatable joints 20a-20c are illustrated in FIGS. 3C-3D, it should be appreciated that any suitable number of joints can be provided. For example, in some embodiments, one, two, four, five, or more joints can be used. In some embodiments, it can be preferable to include more than one joint, e.g., two, three, four, five, or more joints. Providing more than one joint per arm 4a, 4b can beneficially improve the maneuverability and usability of the flosser device 1, and can enable the user to reach spaces between hard-to-reach posterior teeth. The rotatable joints 20a-20c can be configured to rotate about rotational axes that are transverse to the longitudinal axis L of the handle 2, e.g., about axes that may be generally parallel to the arm axis R along which the arms 4a, 4b are laterally spaced. Moreover, the features of FIGS. 1A-2B can be combined with the features of FIGS. 3A-3D in some embodiments. For example, in some embodiments, the arm assembly 3, including the first and second arms 4a, 4b, can be removably connected to the handle 2. For example, the arm assembly 3 can include a flange that connects to the handle 2, and the joints 20a-20c can provide angular adjustment of the arms 4a, 4b relative to the handle 2.

In addition, as shown in FIG. 3A, the flosser device 1 can include a fluid reservoir 17 coupled to or formed with the handle 2 (e.g., disposed inside the handle 2 in some embodiments) and a liquid supply line 18 extending from the fluid reservoir 17 to the first flosser arm 4a to supply a liquid to the dental floss 6 and/or a mouth of the user by way of a liquid outlet 19. In some embodiments, a second supply line (not shown) can additionally or alternatively extend from the fluid reservoir 17 to the second flosser arm 4b. The liquid outlet 19 can comprise an opening in the distal portion 5a, shown in the hand of the character in FIG. 3A. In various embodiments, the liquid can comprise a mouthwash, antibacterial solution, or any other suitable treatment liquid to enhance the efficacy of the flossing. In some embodiments, the handle 2 can comprise a squeezable device, in which the user can squeeze the handle 2 and the reservoir 17 to manually drive the liquid through the supply line 18 to the liquid outlet 19. Skilled artisans would understand that other liquid drive mechanisms may be suitable to deliver the liquid from the reservoir 17 to the outlet 19.

Further, in some embodiments, the flosser device 1 can include a container 16 coupled to or formed with the handle 2. In the embodiment of FIG. 3B, the container 16 can comprise a backpack of the character that forms the handle 2. The dental floss 6 can be stored in the container 6 and can extend from within the container 16 to the first and/or second flosser arms 4a, 4b. In some embodiments, the dental floss 6 can be spooled about a spool or roller within the container 16. In some embodiments, the user can pull the floss 6 to unspool the floss 6 from the roller in the container 16. In other embodiments, the container 16 can be used to contain the liquid to be dispensed over the floss 6.

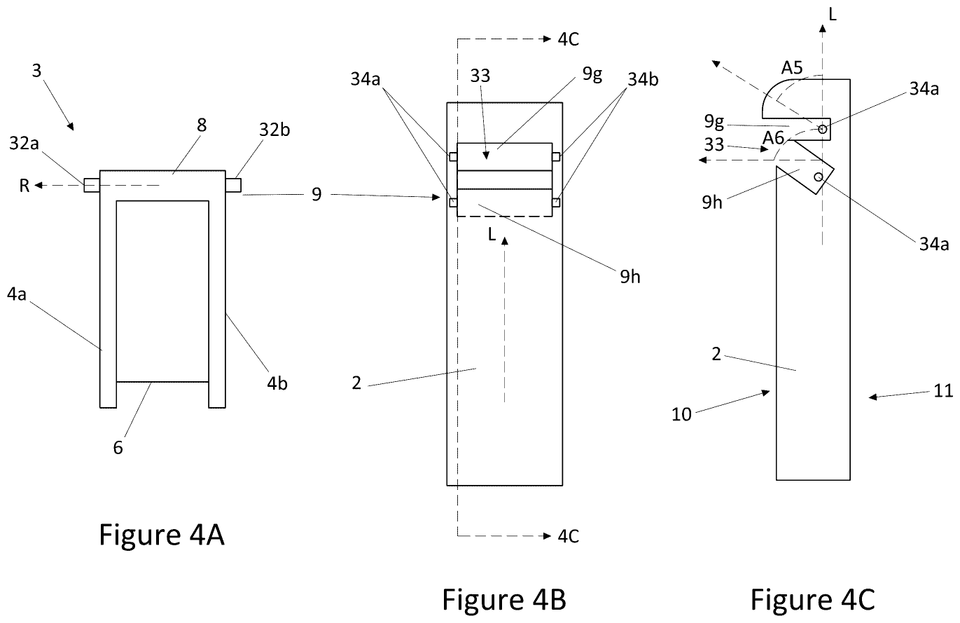

FIGS. 4A-4C illustrate another embodiment of a flosser device 1 having adjustable arms 4a, 4b configured to be adjusted at a plurality of angular orientations. Unless otherwise noted, reference numerals in FIGS. 4A-4C illustrate components that may be the same as or generally similar to like-numbered components of FIGS. 1A-3D. For example, as with FIGS. 1A-3D, the flosser device 1 can comprise a handle 2 configured to be held by a user, the handle 2 extending along a longitudinal axis L of the flosser device 1. The flosser arm assembly 3 of FIG. 4A can be removably connected to the handle 2. The flosser arm assembly 3 can include a first flosser arm 4a and a second flosser arm 4b spaced apart from one another along an arm axis R that is generally transverse to the longitudinal axis L.

Further, as with the embodiments of FIGS. 1A-2B, the flosser device 1 can include a connection mechanism 9 configured to removably connect the flosser arm assembly 3 to the handle 2 at a plurality of angular orientations relative to the longitudinal axis L of the handle 2. As explained herein, the connection mechanism 9 can position the flosser arm assembly 3 at a fifth angle A5 relative to the longitudinal axis L in a first operational configuration of the flosser device 1. The connection mechanism 9 can position the flosser arm assembly 3 at a sixth angle A6 relative to the longitudinal axis L in a second operational configuration, the sixth angle A6 different from the fifth angle A5. In various disclosed embodiments, the connection mechanism 9 can be configured to move from the first operational configuration to the second operational configuration by a physical separation between the flosser arm assembly 3 and the handle 2, followed by a subsequent physical connection between the flosser arm assembly 3 and the handle 2 at a different angle, or vice versa (e.g., from the second operational configuration to the first operational configuration).

As with the embodiments of FIG. 1A-1F, in FIGS. 4A-4C, the connection mechanism 9 can comprise a plurality of slots 9g, 9h formed in the front side 10 of the handle 2. As shown, the slot 9g can be formed at the fifth angle A5 relative to the longitudinal axis L of the handle, as explained above. The slot 9h can be formed at the sixth angle A6 relative to the longitudinal axis L of the handle. In various embodiments, the fifth angle A5 can be the same as or similar to the second angle A2. For example, the fifth angle A5 can be in a range of 25° to 45°, in a range of 30° to 50°, in a range of 35° to 50°, in a range of 35° to 45°, or in a range of 35° to 40°, e.g., about 37° in some embodiments. In various embodiments, the sixth angle A6 can be similar to or the same as the first angle A1. For example, the sixth angle A6 can be in a range of 80° to 100°, in a range of 85° to 95°, in a range of 89° to 91°, or in a range of 89.5° to 90.5° e.g., about 90° in some embodiments.

The slots 9g. 9h can be provided through a common aperture 33 at a common location along the longitudinal axis L. The connection mechanism 9 of FIGS. 4A-4C can further comprise the connection flange 8 of the flosser arm assembly 3. In the embodiment of FIGS. 4A-4C, the connection flange 8 can serve as a connecting member to removably connect to the slots 9g. 9h. As shown, a first pin 32a can extend from the flosser arm assembly 3 along a first direction parallel to the arm axis R, and a second pin 32b can extend from the flosser arm assembly 3 along a second direction parallel to the arm axis R, the second direction opposite the first direction. In various embodiments, the first and second pins 32a, 32b can be integrally formed along outer surfaces of the arm assembly 3 as shown. For example, as shown in FIG. 4A, the first and second pins 32a, 32b can extend away from each other and away from the arms 4a, 4b. The pins 32a, 32b can be sized and shaped to be removably inserted into corresponding notches 34a. 34b formed in the handle 2 adjacent the slots 9g. 9h. For example, the notches 34a, 34b can be disposed laterally outward of the slots 9g. 9h.

In use, the flosser arm assembly 3 can flex such that the user can lightly squeeze the arms 4a, 4b together by pressing the arms 4a, 4b inwardly along the arm axis R. To place the flosser assembly 3 at the fifth angle A5, e.g., into the slot 9g, the user can flex the arms 4a, 4b inwardly, insert the pin 32a into the corresponding notch 34a associated with slot 9g, and insert the pin 32b into the corresponding notch 34b associated with slot 9g. The pins 32a. 32b and notches 34a, 34b can serve to secure the flosser arm assembly 3 to the handle 2. To move the flosser device 1 to a different operational configuration, the user can physically separate the flosser arm assembly 3 from the handle 2 by inwardly squeezing the arms 4a, 4b, and removing the flosser arm assembly 3 from the handle 2. The user can subsequently insert the flange 8 into slot 9h to position the flosser arms 4a, 4b at the sixth angle A6. To removably secure the assembly 3 to the handle, the user can inwardly press the flosser arms 4a, 4b towards one another, insert the pin 32a into the corresponding notch 34a associated with slot 9h, and insert the pin 32b into the corresponding notch 34b associated with slot 9h. As explained above, the flosser device 1 of FIGS. 4A-4C can beneficially enable the user to adjustably position the flosser arms 4a, 4b relative to the handle 2 at a plurality of angular orientations to improve the efficacy of flossing.

Unless the context clearly requires otherwise, throughout the description and the claims, the words “comprise.” “comprising.” “include,” “including” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein.” “above,” “below.” and words of similar import, when used in this application, shall refer to this application as a whole and not to any particular portions of this application. Moreover, as used herein, when a first element is described as being “on” or “over” a second element, the first element may be directly on or over the second element, such that the first and second elements directly contact, or the first element may be indirectly on or over the second element such that one or more elements intervene between the first and second elements. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may.” “e.g.,” “for example.” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments.

While certain embodiments have been described, these embodiments have been presented by way of example only, and are not intended to limit the scope of the disclosure. Indeed, the novel apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. Each of these blocks may be implemented in a variety of different ways. Any suitable combination of the elements and acts of the various embodiments described above can be combined to provide further embodiments. The accompanying claims and their equivalents are intended to cover such forms or modifications as would fall within the scope and spirit of the disclosure.

What is claimed is:

1. A flosser device comprising:
a handle configured to be held by a user, the handle extending along a longitudinal axis of the flosser device;
a flosser arm assembly configured to support dental floss during use by the user, the flosser arm assembly configured to removably connect to the handle at a first connection location to position the flosser arm assembly at a first angle relative to the longitudinal axis, the flosser arm assembly further configured to removably connect to the handle at a second connection location to position the flosser arm assembly at a second angle relative to the longitudinal axis, the second angle different from the first angle, the second connection location spaced from the first connection location along the longitudinal axis.

2. The flosser device of claim 1, wherein the handle comprises a first slot at the first connection location and a second slot at the second connection location, the first slot extending into the handle at the first angle and the second slot extending into the handle at the second angle.

3. The flosser device of any one of claims 1 to 2, wherein the flosser arm assembly comprises a first arm extending from a connection flange and a second arm extending from the connection flange, the first arm spaced apart from the second arm, the connection flange sized and shaped to be removably insertable into the first and second slots.

4. The flosser device of claim 3, wherein the at least one connection flange is removably engageable with the first and second slots by way of a snap-fit connection.

5. The flosser device of claim 3 or 4, further comprising the dental floss, the dental floss extending between the first and second arms.

6. The flosser device of claim 5, further comprising a container coupled to or formed with the handle, the dental floss extending from within the container to the first and second arms.

7. The flosser device of any one of claims 3 to 6, wherein each of the first and second arms comprises a plurality of joints, the plurality of joints configured to adjust an angle between distal ends of the first and second arms and the longitudinal axis of the handle.

8. The flosser device of any one of claims 1 to 7, wherein the first and second slots are formed in a front side of the handle, the front side of the handle configured to face the user during operation of the flosser device.

9. The flosser device of any one of claims 1 to 8, wherein the first angle is in a range of 30° to 50°, and wherein the second angle is in a range of 80° to 100°.

10. The flosser device of claim 9, wherein the first angle is in a range of 35° to 45°, and wherein the second angle is in a range of 89° to 91°.

11. The flosser device of any one of claims 1 to 10, wherein the first and second slots are formed in a back side of the handle, the back side of the handle configured to face away from the user during operation of the flosser device.

12. The flosser device of any one of claims 1 to 11, further comprising a fluid reservoir coupled to or formed with the handle and a liquid supply line extending from the fluid reservoir to the arm assembly to supply a liquid to the dental floss and/or a mouth of the user.

13. A flosser device comprising:
a handle configured to be held by a user, the handle extending along a longitudinal axis of the flosser device;
a flosser arm assembly configured to support dental floss during use by the user; and
a connection mechanism configured to removably connect the flosser arm assembly to the handle at a plurality of angular orientations relative to the longitudinal axis of the handle,
wherein the connection mechanism positions the flosser arm assembly at a first angle relative to the longitudinal axis in a first operational configuration of the flosser device, and
wherein the connection mechanism positions the flosser arm assembly at a second angle relative to the longitudinal axis in a second operational configuration, the second angle different from the first angle, the connection mechanism configured to move from the first operational configuration to the second operational configuration by a physical separation between the flosser arm assembly and the handle followed by a subsequent physical connection between the flosser arm assembly and the handle at the second angle.

14. The flosser device of claim 13, wherein the connection mechanism comprises at least one connecting member and at least one slot, wherein one of the at least one connecting member and the at least one slot is coupled to or formed with the handle, and wherein the other of the at least one connecting member and the at least one slot is coupled to or formed with the flosser arm assembly.

15. The flosser device of claim 14, wherein the flosser arm assembly comprises the at least one connecting member, and wherein the at least one slot comprises a plurality of slots formed in the handle.

16. The flosser device of claim 15, wherein the plurality of slots are spaced apart along the longitudinal axis of the handle.

17. The flosser device of claim 15, wherein the plurality of slots are provided within a common aperture in the handle.

18. The flosser device of any one of claims 15 to 17, wherein the plurality of slots comprises a first slot extending into the handle at the first angle and a second slot extending into the handle at the second angle.

19. The flosser device of claim 18, wherein the at least one connecting member is removably engageable with the first and second slots by way of a snap-fit connection.

20. The flosser device of any one of claims 15 to 19, wherein the flosser arm assembly comprises a first arm extending from the at least one connecting member and a second arm extending from the at least one connecting member, the first arm spaced apart from the second arm.

21. The flosser device of claim 20, further comprising the dental floss, the dental floss extending between the first and second arms.

22. The flosser device of claim 21, further comprising a container coupled to or formed with the handle, the dental floss extending from within the container to the first and second arms.

23. The flosser device of claim 21 or 22, wherein each of the first and second arms comprises a plurality of joints, the plurality of joints configured to adjust an angle between distal ends of the first and second arms and the longitudinal axis of the handle.

24. The flosser device of any one of claims 15 to 17, wherein the plurality of slots are formed in a front side of the handle, the front side of the handle configured to face the user during operation of the flosser device.

25. The flosser device of any one of claims 13 to 24, wherein the first angle is in a range of 30° to 50°, and wherein the second angle is in a range of 80° to 100°.

26. The flosser device of claim 25, wherein the first angle is in a range of 35° to 45°, and wherein the second angle is in a range of 89° to 91°.

27. The flosser device of any one of claims 15 to 17, wherein the plurality of slots are formed in a back side of the handle, the back side of the handle configured to face away from the user during operation of the flosser device.

28. The flosser device of any one of claims 13 to 27, further comprising a fluid reservoir coupled to or formed with the handle and a liquid supply line extending from the fluid reservoir to the arm assembly to supply a liquid to the dental floss and/or a mouth of the user.

29. The flosser device of claim 14, wherein the at least one connecting member comprises a projection coupled to or formed with the handle, and wherein the at least one slot comprises a plurality of slots formed at a plurality of angular orientations in the flosser arm assembly.

30. A flossing method comprising:
removably connecting a flosser arm assembly to a handle at a first angle relative to a longitudinal axis of the handle;
physically separating the flosser arm assembly from the handle; and
removably connecting the flosser arm assembly to the handle at a second angle relative to the longitudinal axis of the handle, the second angle different from the first angle.

31. The flossing method of claim 30, wherein removably connecting the flosser arm assembly to the handle at the first angle comprises inserting a connection flange of the flosser arm assembly into a first slot formed in the handle at the first angle, and wherein removably connecting the flosser arm assembly to the handle at the second angle comprises inserting the connection flange into a second slot formed in the handle at the second angle.

32. The flossing method of claim 30, wherein removably connecting the flosser arm assembly to the handle at the first angle comprises inserting a projection of the handle into a first slot formed in the flosser arm assembly at the first angle, and wherein removably connecting the flosser arm assembly to the handle at the second angle comprises inserting the projection into a second slot formed in the flosser arm assembly at the second angle.

33. A flossing device comprising:
a handle configured to be held by a user, the handle extending along a longitudinal axis of the flosser device; and
a first flosser arm having a first proximal portion connected to the handle and a first distal portion opposite the first proximal portion, the first distal portion configured to support dental floss during use by the user, the first flosser arm including a first plurality of rotatable joints configured to position the first distal portion at a first plurality of angular orientations relative to a mouth of the user.

34. The flossing device of claim 33, further comprising a second flosser arm spaced apart from the first flosser arm, the second flosser arm having a second proximal portion connected to the handle and a second distal portion opposite the second proximal portion, the second distal portion configured to support the dental floss during use by the user, the second flosser arm including a second plurality of rotatable joints configured to position the second distal portion at a second plurality of angular orientations relative to the mouth of the user.

35. The flossing device of claim 34, wherein each of the first and second flosser arms comprises a first segment connected to the handle by a first rotatable joint at the proximal portion of the first flosser arm and a second segment connected to the first segment by a second rotatable joint.

36. The flossing device of claim 35, wherein the first and second rotatable joints are configured to rotate about rotational axes that are transverse to the longitudinal axis of the handle.

37. The flossing device of claim 36, wherein the first and second flosser arms are spaced apart along an arm axis parallel to the rotational axes.

38. The flossing device of any one of claims 35 to 37, wherein each of the first and second flosser arms comprises a third segment connected to the second segment by a third rotatable joint, the third segment comprising the respective first and second distal portions.

39. The flossing device of any one of claims 35 to 38, further comprising a fluid reservoir coupled to or formed with the handle and a liquid supply line extending from the fluid reservoir to the first flosser arm to supply a liquid to the dental floss and/or a mouth of the user.

40. The flossing device of any one of claims 35 to 39, further comprising the dental floss and a container coupled to or formed with the handle, the dental floss extending from within the container to the first flosser arm.

41. A flosser device comprising:
a handle configured to be held by a user, the handle extending along a longitudinal axis of the flosser device, the handle comprising a first slot extending into the handle at a first angle and a second slot extending into the handle at a second angle that is different from the first angle;
a flosser arm assembly configured to support dental floss during use by the user, the flosser arm assembly configured to removably connect to the handle, the flosser arm assembly comprising a connection flange configured to removably engage with the first and second slots to position the flosser arm assembly at the respective first and second angles.

42. The flosser device of claim 41, wherein the flosser arm assembly comprises a first arm extending from the connection flange and a second arm extending from the connection flange, the first arm spaced apart from the second arm.

43. The flosser device of claim 41 or 42, wherein the at least one connection flange is removably engageable with the first and second slots by way of a snap-fit connection.

44. The flosser device of any one of claims 41 to 43, further comprising the dental floss, the dental floss extending between the first and second arms.

45. The flosser device of any one of claims 41 to 44, wherein the first and second slots are spaced apart along the longitudinal axis of the handle.

46. The flosser device of any one of claims 41 to 44, wherein the first and second slots are provided within a common aperture in the handle.
